(19) United States
(12) Patent Application Publication
(10) Pub. No.: US 2021/0371026 A1
(43) Pub. Date: Dec. 2, 2021

(54) ADJUSTABLE LOCKING MECHANISM

(71) Applicants: Mark William Haimes, Garibaldi Highlands (CA); Jaan Peter Aked-Hurditch, Whistler (CA)

(72) Inventors: Mark William Haimes, Garibaldi Highlands (CA); Jaan Peter Aked-Hurditch, Whistler (CA)

(21) Appl. No.: 17/206,067

(22) Filed: Mar. 18, 2021

Related U.S. Application Data
(60) Provisional application No. 62/963,067, filed on Jan. 19, 2020.

(51) Int. Cl. B62H 3/00

(52) U.S. Cl. CPC B62H 3/00

(57) ABSTRACT

An adjustable locking mechanism may include a base member having an anchor portion and a first bearing surface. A flexible, rope like retaining member may have a body portion that is resiliently compressible and defines a retaining member width and that may be substantially inextensible along its length and the body portion. At least first and second securing recesses may be formed in the base member and can include a receiving portion configured to accommodate the body portion of the retaining member, a throat portion extending to the receiving portion and having a throat width that is less than a receiving portion width and the retaining member width, and a shelf surface formed at the intersection of the receiving portion and the throat portion and facing the receiving portion.

### CROSS-REFERENCE TO PRIOR APPLICATION

This application claims the benefit of U.S. provisional patent application No. 62/963,067, filed Jan. 19, 2020 and entitled Rope Lock, the entirety of which is incorporated herein by reference.

### FIELD OF THE INVENTION

These teachings described herein relate to adjustable locking mechanisms or tie downs, and more specifically to adjustable tie downs that use a flexible locking member and that can be used on racks fitted to vehicles for the purpose of transporting bicycles, though it could also be used to secure any one object to another.

### INTRODUCTION

U.S. Pat. No. 6,044,669 discloses a variably-sized strap lock that includes a strap and a lock body. The strap consists of a free end portion, a hinge portion and a lock portion. A variably-sized loop is formed by inserting the strap into the lock body and pulling the strap through the lock body to remove excess slack. The lock body engages either a series of teeth or a pair of chain-like members located on the strap and prevents withdrawal without disengagement by the user. A pair of hinges or the pair of chain-like members of the strap allow the hinge portion of the strap to lie flush against the lock body portion of the strap thus allowing the strap lock to be tightly secured onto an object to prevent rattling or inadvertent disengagement.

U.S. Patent Publication No. US2006/0213941 discloses a ratcheting strap-down system for use with a crossbar to securely transport any variety of objects. The ratcheting strap-down assembly includes a ratcheting receiver and a cam clamp receiver. The ratcheting receiver includes a ratcheting assembly and a locking mechanism and is adapted to engage a second end of a flexible strap. The flexible strap is preferably made from reinforced steel cog belt, making the system and the objects it's securing less susceptible to theft. The ratcheting strap-down system is particularly useful for securing one or more surfboards to the crossbars of an after-market roof rack assembly.

U.S. Pat. No. 9,682,806 discloses a cable lacing tie device includes a head assembly and a cable lacing tape. The head assembly being configured to retain a first portion of the cable lacing tape within the head assembly and having a length of the cable lacing tape extending from the head assembly. The head assembly further adapted to retain a second portion of the cable lacing tape extending from the head assembly. The methods of using the cable lacing tie devices include retaining a first portion of a cable lacing tape in a head assembly, looping the cable lacing tape around a plurality of objects, and retaining a second portion of the cable lacing tape within the head assembly.

U.S. Pat. No. 3,590,608 discloses a locking device adapted to prevent the theft of an object by tethering the object to a fixture. The device comprises an elongated, flexible cable with a fixed loop at one end and means for providing a flexible variable-sized, releasable binding at the other end.

U.S. Patent Publication No. US2020/0055458 discloses a carrier rack mountable to a vehicle includes a splined member, a first arm rotationally coupled about the splined member, and a latch coupled to the first arm. The splined member includes a plurality of splines disposed along an external surface of the splined member. The splined member is disposed through an aperture in a proximal end of the first arm. The latch is configured to engage the splined member to fix the first arm about the splined member.

U.S. Pat. No. 5,190,195 discloses a bicycle rack adapted to be detachably mounted to a passenger vehicle via a standard trailer hitch with the bicycle rack having a vertical support pivotally connected at one end to a base assembly with an upper crossbar assembly pivotally connected to the other end via a removable and reversible crossbar bracket on which a clamp arm is removably mounted. A pull pin releasably locks the vertical tube in an upright position to the base assembly and another pull pin locks the upper crossbar assembly in a horizontal position to the vertical support. Spacers may be removably inserted in downwardly depending flanges of the base assembly to mount it to a relatively narrow trailer hitch.

### SUMMARY

Bicycles, kayaks, paddle boards, surf boards, skis and other types of equipment often need to be transported between different locations. For example, riders wishing to go downhill mountain biking may need to travel to a suitable biking location and may need to transport their bikes with them. If travelling by car, truck or other similar vehicle a suitable carrier rack can be mounted on the vehicle and can hold the bicycle (or other equipment) during travel. Preferably, the bicycle can be held securely or locked in place on the carrier rack during transportation so that the bicycle does not fall off the rack or rattle, shake or shift during transit which may cause damage to the bicycle, the carrier rack and/or the vehicle. It is desirable for such locking mechanisms to be relatively easy to operate by the user (e.g. easily engageable and disengageable).

Bicycles, kayaks and any other such objects that may be carried on a corresponding carrier rack may come in different sizes and configurations. For example, bicycles may come with different frame sizes, wheel diameters, tire width/thicknesses and the like. Preferably, a locking mechanism that is used to secure the object (e.g. a bicycle) to the carrier rack can be adjusted by a user to secure objects of different sizes/shapes, etc. for any given trip/use of the carrier rack, while still being able to hold them securely enough to avoid damage. It is preferable that such adjustment need not require substantial reconfiguration of the locking apparatus hardware, and preferably can be done by a user without requiring tools. Further, to help account for such differences in the objects being secured the locking mechanism is preferably finely and/or continuously adjustable so that it can be locked precisely around a given object, rather than being securable in a plurality of discrete locking positions or steps which may not be specifically configured for a given object. Existing methods used to secure bicycle wheels to bicycle racks tend to have issues that make them less ideal.

A first example of a mechanism or technique for securing an object, such as a bicycle, is plastic ratchet straps. These have a tendency to break and are costly to replace, and also have a tendency to scratch the bicycle rim surface as they employ hard plastic that comes in direct contact with the rim.

Another example of a mechanism or technique for securing an object is the use of rubber straps with holes that are placed over an insert to hold them at the desired length. These are limited in adjustment to the spacing between the holes. They are also made of rubber (which is elastic/extensible) that can stretch while trying to engage the lock but that can also stretch when loaded/engaged. Stretching of the rubber straps after they have been secured/engage can allow further deformation of the straps and can mean that they don't hold the wheel as securely in the rack as other securing mechanisms. This can lead to vibrations while the carrier rack is in use. These straps also have a tendency to break and are costly to replace as they are often propriety or specialized design for a given rack, and require properly located holes, etc. The elasticity and flexibility of a rubber strap can also vary with temperature, and such straps may not perform as well in cold weather/climate as they do in warm climates.

Another example of a mechanism or technique for securing an object is to use ropes with a one or more knots that can fit into predetermined slots. In this design, the user must tie a knot in the rope at the right location so that the rope can be pulled tight around the wheel and the knot placed into a slot to hold the rope in place. If there is not a knot in the exact right position, the wheel may not be secured properly. The user will as a result end up with a large number of knots in the rope, that typically end up all being in less than ideal locations, making it difficult to secure properly.

Another example of a mechanism or technique for securing an object is to use elastic shock cord or other extensible or elastic cords. This method employs an elastic shock cord or the like with a plastic ball or other securing member on the end. The cord is stretched over the wheel and goes into one of a choice of slots in a corresponding frame and the plastic ball prevents the cord from being pulled axially through the slot. One shortcoming of this mechanism is that the extensible cord is flexible enough that the wheels are not held securely enough unless the cord is pulled to maximum stretch capacity, because any remaining stretch in the cord may allow the bicycle to shift relative to the carrier rack (similar to the rubber straps). The inventors have also discovered that stretching such elastic cords to their elastic deformation limit can make them prone to snapping or to otherwise break catastrophically, and usually with without warning as discovered by testing with this method. The series of slots in the corresponding frame typically does not provide enough adjustability in the cord length to allow a variety of tire widths to be held at maximum stretch capacity. Typically, the user will run it less than 100% stretched, so the wheel is not held securely and will move when subjected to bumps as the cord stretches.

Another example of a mechanism or technique for securing an object is to use bicycle inner tubes or tires. Many non-commercial racks have been designed to use pieces of inner tubes or bicycle tires as a stretchable material that can be stretched the wheel and either tie a knot in the inner tube, or put a series of holes in the tire to place over a pin to hold it in place. These methods tend to be cumbersome to use and can be less secure than methods using a purpose-built strap.

There remains a need for an improved, adjustable locking mechanism that can be used to secure and object, such as bicycle or the like, to a carrier rack.

In accordance with one broad aspect of the teachings described herein, an adjustable locking mechanism for releasably securing a bicycle having a rim and a tire to a rack can include a base member connectable to a rack and having a first edge extending in a longitudinal direction, an anchor portion and a first bearing surface configured to bear against a tire of a bicycle. A flexible, rope like retaining member may have a body portion defining a retaining member width and may extend between a first end that is securable to the anchor portion and a free, second end. The retaining member may be substantially inextensible along its length and the body portion may be resiliently compressible. At least three securing recesses may be formed in the base member and may be longitudinally spaced apart from each other. Each securing recess may include a receiving portion extending through the base member and configured to accommodate the body portion of the retaining member and having a receiving portion width; a throat portion extending laterally inwardly from first edge of the base member to the receiving portion and having a throat width that is less than the receiving portion width and the retaining member width; and a shelf surface formed at the intersection of the receiving portion and the throat portion and facing the receiving portion. When the tire is bearing against the first bearing surface and the retaining member is tightened over the tire and a rim of the bicycle to urge the tire against the first bearing surface: the locking mechanism may be engaged by laterally sliding the body portion of the retaining member through the throat portions with sufficient insertion force to compress the body portion to the throat width and allow it to travel through the throat portions to the receiving portions where the body portion expands to the receiving portion width and lateral removal of the retaining member from the receiving portions is inhibited by interference between the retaining member and the shelf surfaces; and the locking mechanism may be disengaged by laterally pulling the retaining member from the receiving portions with a removal force that is sufficient to overcome the interference between the retaining member and the shelf surfaces, thereby causing the body portion of the retaining member to compress to the throat width and to be laterally removed via the throat portions.

In accordance with another broad aspect of the teachings described herein, which may be used alone or in combination with other aspects, an adjustable locking mechanism for releasably securing an object may include a base member having a first edge extending in a longitudinal direction, an anchor portion and a first bearing surface configured to bear against the object. A flexible, rope like retaining member may have a body portion defining a retaining member width and extending between a first end that is securable to the anchor portion and a free, second end. The retaining member may be substantially inextensible along its length and the body portion may be resiliently compressible. At least first and second securing recesses may be formed in the base member and may be longitudinally spaced apart from each other. Each securing recess may include: a receiving portion extending through the base member and configured to accommodate the body portion of the retaining member and having a receiving portion width; a throat portion extending laterally inwardly from first edge of the base member to the receiving portion and having a throat width that is less than the receiving portion width and the retaining member width; and a shelf surface formed at the intersection of the receiving portion and the throat portion and facing the receiving portion.

A third securing recess may be formed in the base and may be longitudinally spaced from the first and the second securing recesses.

When the object is bearing against the first bearing surface and the retaining member is tightened over the object to urge the object against the first bearing surface: the locking mechanism may be engaged by laterally sliding the body portion of the retaining member through the throat portions with sufficient insertion force to compress the body portion to the throat width and allow it to travel through the throat portions to the receiving portions where the body portion expands to the receiving portion width and lateral removal of the retaining member from the receiving portions is inhibited by interference between the retaining member and the shelf surfaces; and the locking mechanism may be disengaged by laterally pulling the retaining member from the receiving portions with a removal force that is sufficient to overcome the interference between the retaining member and the shelf surfaces, thereby causing the body portion of the retaining member to compress to the throat width and to be laterally removed via the throat portions.

A plurality of securing recess may be formed in the base and may be longitudinally spaced from each other and from the first, second and third securing recesses.

The receiving portion width may be equal to or greater than the retaining member width.

The retaining member width may remain substantially constant along its length.

Each throat portion may be substantially linear and may extend along a throat axis that intersects the longitudinal direction.

The retaining member width may be between about 4 mm and 30 mm.

The retaining member may be detachable from the base member by disconnecting the first end of the retaining member from the anchor portion.

A replacement retaining member may be attachable to the base member in place of the retaining member by connecting a first end of replacement retaining member to the anchor portion.

The anchor portion may include an aperture extending through the base member that is sized to receive the flexible retaining member. The first end of the flexible retaining member may include a stopper portion that cannot pass through the aperture.

The stopper portion may include a knot tied toward the first end of the flexible retaining member.

The throat width may be between 85% and 99% of the retaining member width.

The retaining member may include at least one of a rope, a wire, a cable.

The retaining member may be a piece of multi-strand rope.

An outer surface of the retaining member may be configured to be softer than an outer surface of the object, whereby the retaining member will not scratch the outer surface of the object.

A flange may extend from the base between a root and a free end and may have an inner surface that overhangs the base and may include a second bearing surface. The second bearing surface may be spaced from the first bearing surface and may be configured to bear against a second portion on the object when the object is secured with the locking mechanism.

The anchor location may be laterally proximate the root of the flange and may be overlaid by the flange.

The inner surface of the flange may be generally planar and may extend at a flange angle relative to the base. The flange angle may be between 15 and 75 degrees.

Other advantages of the invention will become apparent to those of skill in the art upon reviewing the present specification.

### BRIEF DESCRIPTION OF THE DRAWINGS

Embodiments of the present invention will be described with reference to the accompanying drawings, wherein like reference numerals denote like parts, and in which:

FIG. 1 is a perspective view of one example of an adjustable locking mechanism;

FIG. 2 is a front view of the adjustable locking mechanism of FIG. 1;

FIG. 3 is a bottom view of the adjustable locking mechanism of FIG. 1;

FIG. 4 is a front view of the adjustable locking mechanism FIG. 1 engaged with a first bicycle tire;

FIG. 5 is a front view of the adjustable locking mechanism FIG. 1 engaged with a second bicycle tire; and

FIG. 6 is a perspective view of another example an adjustable locking mechanism.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

The teachings described herein relate to an improved, adjustable locking mechanism that can be used to securely retain an object. One application of the present teachings is to securely attach a bicycle to a bicycle storage rack (e.g. a generally stationary rack) and/or carrier rack that can be used during transport, and an example of locking mechanisms that are suitable for this purpose are described herein. However, use of the described locking mechanisms need not be limited to securing bicycles to storage or carrier racks. Other examples of locking mechanisms may be used to secure bicycles to other structures and/or to secure other suitable equipment, such as kayaks, paddle boards, surf boards, skis and other types of equipment that often need to be transported between different locations. To adapt the locking mechanisms described herein for such purposes the base of the mechanism may be sized and shaped to be generally complementary to the expected shapes of the objects that are to be secured, the length of the associated retaining member may be set accordingly, and the number, orientation and spacing of the securing recesses may be adjusted from what is shown herein.

The locking mechanisms described herein may help address at least some of the shortcomings of conventional attachment devices. For example, interaction between a generally rope like retaining member and its associated securing recesses can provide a securing mechanism that can be described as continuously adjustable as the retaining member can be pulled tight to any desired length and secured at that length relatively easily.

Preferably, the retaining member used has a relatively limited extensibility or stretchablility/elasticity, and optionally be at least substantially inelastic/inextensible along its length when subjected to its expected, generally axial/lengthwise loading conditions. In this arrangement, once the retaining member is tightened by a user the retaining member does not significantly or materially further stretch or deform while in use which would loosen the locking mechanism or otherwise allow further movement of the bicycle relative to the securing mechanism base.

The preferred materials for the retaining member may include a multi-strand, static rope or cord, such as paracord of the same type that is commonly utilized for rock climbing and other outdoor activities. Such materials are relatively low cost and are available from multiple different vendors in the industry. This means that if the original retaining member provided with the locking mechanism should become worn or damaged, or if the use simply wishes to change its length, colour or other features, the retaining member can be easily replaced by the user.

The retaining member is also preferably made from materials that can provide a relatively soft outer surface, that is expected to be in direct contact with the object being secured. That is, an outer surface of the retaining member may preferably be configured to be softer than an outer surface of the object, which may help ensure that the retaining member will not scratch the outer surface of the object.

Optionally, the retaining member may have the same composition all the way through (such as a rope), or may have a core made from one material and an outer cover that is made from a different material to help obtain the desired combination of mechanical properties (such as a metal cable that is coated with a plastic or fabric outer sheath or coating). Having a relatively soft outer surface may help reduce the chances of the retaining member scratching or otherwise damaging the bicycle rim or other portions of the object being held.

Unlike elastic shock cords, the retaining members described herein may be relatively less likely to break without warning when loaded. For example, the type of ropes described herein as suitable examples of the retaining member may tend to show visible signs of wear before it becomes too weak to be operational, whereas elastic shock cord tested by the inventors tended to break when the cord still visually appeared to be new or in good condition, with no obviously visible signs of wear.

In addition to the desirable features of the retaining member, the locking mechanisms described herein also include at least two and preferably at least three or more specially designed securing recesses that are spaced apart from each other and configured to receive and retain the retaining member/rope. Providing a plurality of securing recesses at different locations along the base of the locking mechanism can allow a user to pull the retaining member over any particular object that is in contact with the base and to then insert the rope into the closest available/appropriate recess (for example, chosen by the user dependent on tire width), and the retaining member can then can be pulled to the desired tightness. To help fix the retaining member in place the downstream portions of the retaining member can then be inserted into at least one, and preferably at least two more recesses, each of which will create friction with the retaining member and prevent it from sliding through or out of the recesses in its axial/length direction. When woven through 2, 3 or more of the recesses the retaining member will remain sufficiently tight to secure the object. That is, once threaded in this manner through 2, 3 or more recesses the rope is rendered substantially unable to move axially until such time as the user pulls the rope out of the recesses again.

Preferably, the retaining member can be inserted into and extracted from the recesses by pulling it laterally through open channels or portions of the recesses, rather than having to feed the retaining member through closed holes or apertures. This may help simplify the engagement and disengagement processes.

To facilitate the lateral insertion and removal of the retaining member from the securing recesses the spacing and shape of the slots/recesses has been created by the inventors based on testing multiple shapes and sizes. Testing of these various designs revealed that some shapes and sizes failed to hold the rope under the type of forces that will be presented under normal use, while others made it too difficult to secure and release the rope efficiently. It was after trialing multiple examples that this specific design came to be the one that met the requirements of being adequately secure and sufficiently easy to operate.

The preferred configuration of the securing recesses developed includes an opening or throat portion that is narrower than the retaining member (e.g. rope) being used. The throat may also be tapered so that it begins equal to or wider than the retaining member at the start (outboard portion) of the throat, but then tapers to be narrower than the retaining member towards the inner end of the throat portion where it meets the retaining member. As described herein, the throat width is understood to mean the width at the inner or inboard end of the throat portion, adjacent the retaining member. Alternatively, the throat portions may have a generally constant width. In either arrangement, forcing the retaining member to pass through these relatively narrow throat portions proximate the retaining portions can cause the rope to laterally compress to the throat width. This throat portion leads to a hole or receiving portion that is sized so that it is equal to or larger in width/diameter than the width of the throat portion, which can allow the compressed rope to expand to the width of the receiving portion. This may be advantageous because once positioned in the receiving portion the rope would then be required to re-compress in order for it to move back into and through the throat portion. Such compression may help enhance a frictional force between the rope and the throat portion which helps hold the rope in place within the receiving portion and inhibits it from being shaken out via the throat portion. This may be particularly useful in applications of this locking mechanism where it is subject to movement or vibrations, such as being part of a carrier rack that is mounted on a moving vehicle, because mechanisms in such scenarios are subjected to movement and vibration which tends to shake or dislodge ropes from slots that have a constant width, which may result in tension on the rope being lost and the payload no longer being secured. Testing by the inventors has revealed simply having a series of slots of constant width (instead of the relatively narrow throat portion in communication with the relatively wider receiving portions) may not be sufficient to make the rope secure enough in this application, and that the configuration of the securing recesses described herein provide advantages over such structures.

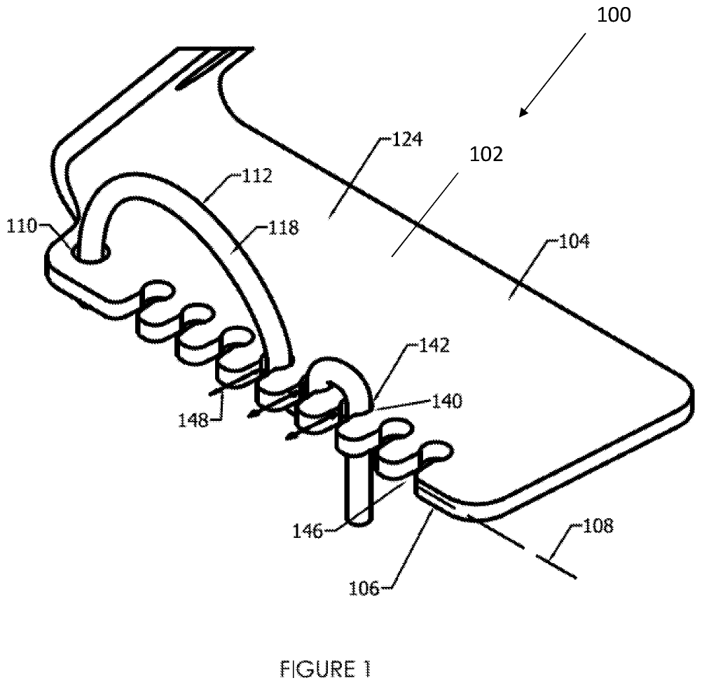

Referring to FIGS. 1 to 3, one example of an adjustable locking mechanism 100 that is configured to hold and secure the wheel/tire of a bicycle is illustrated. This locking mechanism 100 includes a base member in the form of a metal plate 102 that has a generally, solid and flat body portion 104 that is bounded by side edges, including a first edge 106 that extends in a generally longitudinal direction 108. While the edge 106 is shown as being fairly straight or linear in this example, other examples of the locking mechanism may have edges that are somewhat curved, angled or otherwise non-linear but that can still be described as extending generally in a longitudinal direction.

A retaining member, in the form of a flexible and substantially inextensible rope 112 is shown in FIGS. 1 and 3. In this example, the plate 102 also preferably includes an anchor portion to which one end of the retaining member, e.g. a first end 114 of the rope 112, can be attached. In this example, the anchor portion includes an aperture or hole 110 that extends through the plate 102 (from a lower side to an upper side thereof) and that is sided to accommodate the body of the rope 112.

Preferably, the hole 110 is sized to that it can generally freely receive the body of the rope 112, which may help reduce wear on the rope 112, but is small enough so that a stopper portion at the end 114 of the rope 112 cannot pass through the aperture 110. This can secure the rope 112 to the plate 102 such that axially pulling upwardly on the rope 112 will not disconnect the rope 112 from the plate 102. The stopper portion on the rope 112 may be a clip or other member that is connected to the rope 112 or, preferably, may be a knot (such as knot 116) that is tied toward the first end 114 of the flexible rope 112. This may help facilitate the use of any suitable piece of rope to function as the retaining member, and may allow for the set-up or repair of the mechanism 100 without the need for separate parts or hardware to provide the stopper portion.

Optionally, the retaining member/rope 112 may be detachable from the base member/plate 102, for example by disconnecting the first end 114 of the retaining member 112 from the anchor portion 110. This may allow a user to remove any given retaining member and replace it with another retaining member. This may facilitate the replacement of worn or damaged retaining members and/or may allow a user to use different retaining members (such as ropes with different lengths, etc.) when securing different objects while using a common base/plate 102. In this example, the retaining rope 112 can be detached from the anchor aperture 110 by untying the knot 116 and feeding the end 114 through the aperture 110, or by pulling the rope 102 through the aperture 110 until end 122 is pulled free. In this configuration a replacement retaining member can then be attached to the base 102 by reversing the removal steps and connecting a first end of the replacement retaining member to the anchor portion 110.

In this example, the rope 112 is a multi-strand, static cord having a body portion 118 that defines a retaining member width 120 and extends between its first, anchored end 114 and a free, second end 122. Preferably, the rope 112 is substantially inextensible when subjected to tensile or pulling forces along its length and the body portion 118 is at least somewhat resiliently compressible so that if slightly squeezed laterally it can slightly compress/shrink and can then re-expand to at least substantially the same width 120 when the squeezing force is removed. While a rope 112 is used as the retaining member in this example, in other examples the retaining member may be formed from other suitable, rope like materials such as other types of ropes, wires, cables, cords, plastic filaments, webbing and the like. The width 120 may be any desired width that is compatible with the other features of the mechanism 100, and may be, for example between about 4 mm and 30 mm, or may be greater than 30 mm.

Preferably, the retaining member width 120 can remain at least substantially constant along the length of the retaining member/rope 112, and the rope 112 need not include knots, notches, beads or other similar features in order to be engaged and retained by the rest of the mechanism 100. This may help provide a relatively fine, and generally continuous/infinite range of adjustment/securement of the mechanism, as compared to devices that use beads, holes or other such discontinuities along the length of a retaining member to facilitate the locking or retaining of such members as discrete points along their length and do not easily permit locking at distances that fall between any two such beads/discontinuities.

In addition to the anchor hole 110, the plate 102 also provides a bearing surface that is intended to be in contact with, and bear against a portion of the object, e.g. a bicycle tire, when the mechanism 100 is in use. The bearing surface may be of any suitable shape that is complimentary to the shape of the object that is to be secured. It may be provided as an integral part of the body 104 or may be a separate member. In the illustrated example, the upper surface of the plate 102 provides a generally flat bearing surface 124, upon which a bicycle tire can rest. In FIG. 3, a schematic representation of a bicycle tire 126 is illustrated in a use/securing position, in which the tire 126 bears against upper surface 124 or the plate 102. In other examples, the bearing surface may be larger or smaller, and may curved, angled or otherwise configured to accommodate a different object to be secured.

Optionally, as shown in this example, the mechanism 100 may also include additional bearing surfaces that can be positioned to help engage and/or secure the object, such as the bike tire, that is being secured with the mechanism 100. This may help further improve the retaining capabilities of the mechanism 100 and/or may help reduce the amount of stress exerted against the retaining member 112. In this example, the mechanism 100 includes a flange 130 that extends generally away from body portion 104 of the base 102, between a root 132 and a free end 134. In the illustrated arrangement, an inner surface 136 of the flange 130 overhangs the base 104 and defines a second bearing surface 124B. This second bearing surface 124B is spaced from the first bearing surface 124 and is configured so that it could bear against a second portion on the object, such as a second portion of the tire, when the object is secured with the locking mechanism 100. In this example, the anchor location 110 is laterally proximate the root 132 of the flange 130 and is overlaid by the flange 130.

The inner surface of the flange may have any suitable shape, and in the illustrated example the inner surface 136 is generally planar and extends at a flange angle 138 relative to the base 104. The flange angle 138 may be any desired angle that still provides the desired degree of overhang or otherwise positions the second bearing surface 124B in a desired position, and may be between about 0 and about 90 degrees or more, or may be between about 15 and 75 degrees, and preferably may be between 30 and 60 degrees.

To help secure the free end 122 of the rope 112, the mechanism preferably includes at least first and second securing recesses that are configured to receive and retain the rope 112 as described herein. More preferably, as the inventors have determined via testing of prototypes of the described mechanism, the mechanism can include at least three such recesses (e.g. at least a first, a second and a third recess) so that the rope 112 can be engaged/retained in at least three different locations (see locations A, B and C in Figured 3). This may help improve the retention of the rope 112 as compared to using only two recesses. In some examples, the mechanism may include more than three recesses that are spaced apart from each other generally longitudinally, along the length of the body 104. This may help provide a variety of different fastening locations on the base 102, which may allow the rope 112 to be fastened in a variety of different locations, which may in turn help accommodate objects of different sizes using a common base 102 and retaining member 112.

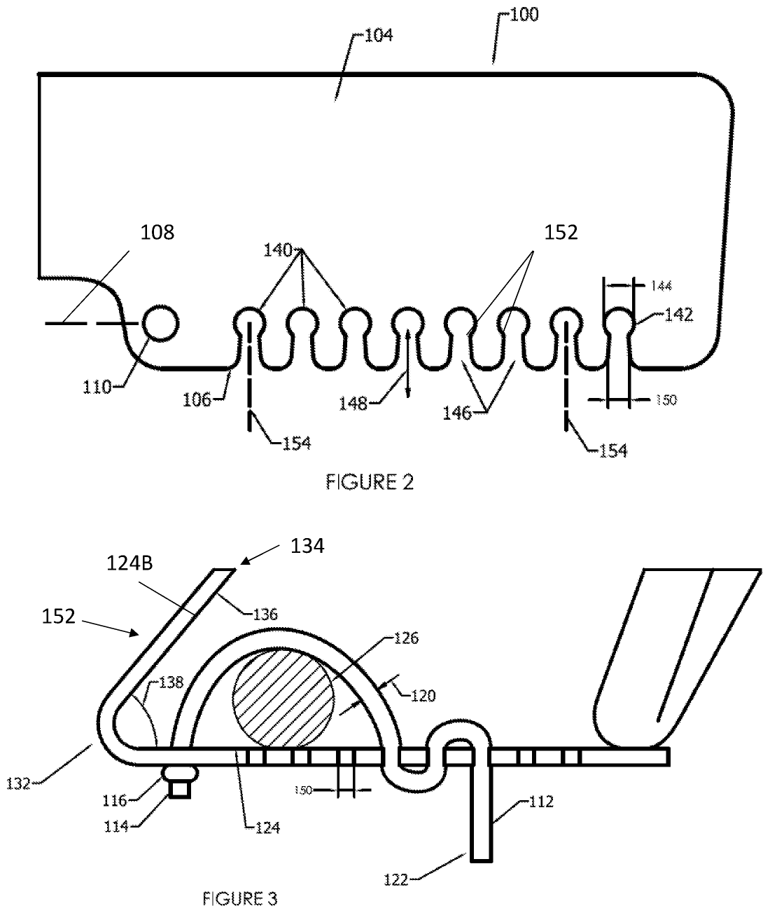

Referring again to FIGS. 2 and 3, in the illustrated example the mechanism 100 includes a plurality of securing recesses 140, which can include at least first, second and third securing recesses. The securing recesses 140 are formed in the base member 104 and are positioned so as to be longitudinally spaced apart from each other in the longitudinal direction 108. In this example, each securing recess 140 includes a receiving portion 142 that extends through the plate 102 and is configured to accommodate the body portion 118 of the retaining member/rope 112. In this example, the receiving portions 142 define a receiving portion width/diameter 144 that can allow the body portion 118 of the rope 112 to fit within the receiving portion 140 in a generally, and preferably, at least substantially uncompressed state. That is, the width 144 is preferably selected to be equal to or greater than the width 120 of the body portion 118 of the rope 112, but optionally may be slightly less than the width 120 of the rope 112 as long as it is still wider than the throat width (as described herein).

To provide access to the receiving portions 142, each securing recess 140 also preferably includes a throat portion 146 that extends generally laterally (e.g. as indicated by arrows 148) inwardly from first edge 106 of the base member/plate 102 to the receiving portion 142. In this example, the throat portions 146 are generally linear (e.g. extend along respective throat axes 154) and their axial direction is the same as the lateral direction 148, and is generally orthogonal to the longitudinal direction 108. In other examples the throat portions 146 do not need to be linear (e.g. they may be curved) and the lateral direction, which can be understood a general direction of travel from the edge 106 to the receiving portions 142 need not be orthogonal to the longitudinal direction 108. Configuring the throat portions 146 in this manner can provide a travel path along with the rope 112 can be laterally inserted into the receiving portions 142, instead of having to be thread or passed axially through the receiving portions (e.g. as would be required if the receiving portions were discrete holes instead of open-sided recesses with throat portions). This can permit the lateral insertion and removal of the rope 112 from the receiving portions, which may help simplify the securing and releasing of the rope 112.

As described herein, the throat portions 146 are configured so that their throat width 150 is less than the receiving portion width 144 and preferably is less than the retaining member width 120. The throat widths 150, at a in board end adjacent the retaining portion, may preferably be between about 85% and 99% of the retaining member width 144. The width at the outboard end of the throat portions 146 may be the same or greater as the throat width at the inboard end such that the throat portions 146 are slightly tapered as shown. This may help provide an opening at the outer end of the throat portion 146 that is larger than the retaining member which may make it easier to align the retaining member 112 with throat portions for ease of insertion, as long as it tapers to the throat width 150 of between 85-99% of the retaining member width 144 adjacent to the receiving portion 142. In this arrangement, a shelf surface is formed at the intersection of the relatively wider receiving portions 142 and their corresponding throat portions 146. These shelf surfaces 152 are generally inwardly facing, and face toward the interior of the receiving portion 142.

In this configuration, if the rope 112 is pressed laterally into the throat portions 146 the rope 112 will be compressed slightly to the throat width 150 due to the interference between the throat portions 146 and the rope body 118. When the rope 112 reaches the relatively wider retaining portion 142 it can then re-expand to a width that is greater than the throat width 150.

To use the illustrated locking mechanism 100, when the object (e.g. bicycle tire 126) is bearing against the first bearing surface 124 the user can then pull the retaining member/rope 112 over the tire 126 (as shown schematically in FIG. 3) and tighten the rope 112 so that the tire 126 is urged against the first bearing surface 124. With the rope 112 pulled to a desired tightness, the locking mechanism 100 is engaged by laterally sliding the body portion 118 of the retaining member through two, and preferably three or more of the throat portions 146 with sufficient insertion force to compress the body portion 118 of the rope 112 to the throat width 150, which can allow it to translate through the throat portions 146 and into the receiving portions 142. When the rope 112 reaches the receiving portions 142 the body portion 118 resiliently expands to the receiving portion width 150 and lateral removal of the retaining member/rope 112 from the receiving portions 142 is inhibited by interference between the retaining member/rope 112 and the shelf surfaces 152.

When a user is ready to remove the bicycle from the mechanism, the locking mechanism can be disengaged by laterally pulling the retaining member/rope 112 from the receiving portions 142 with a removal force that is sufficient to overcome the interference between the retaining member 112 and the shelf surfaces 152, thereby causing the body portion 118 of the retaining member 112 to again compress to the throat width 150 and to be laterally removed via the throat portions 146.

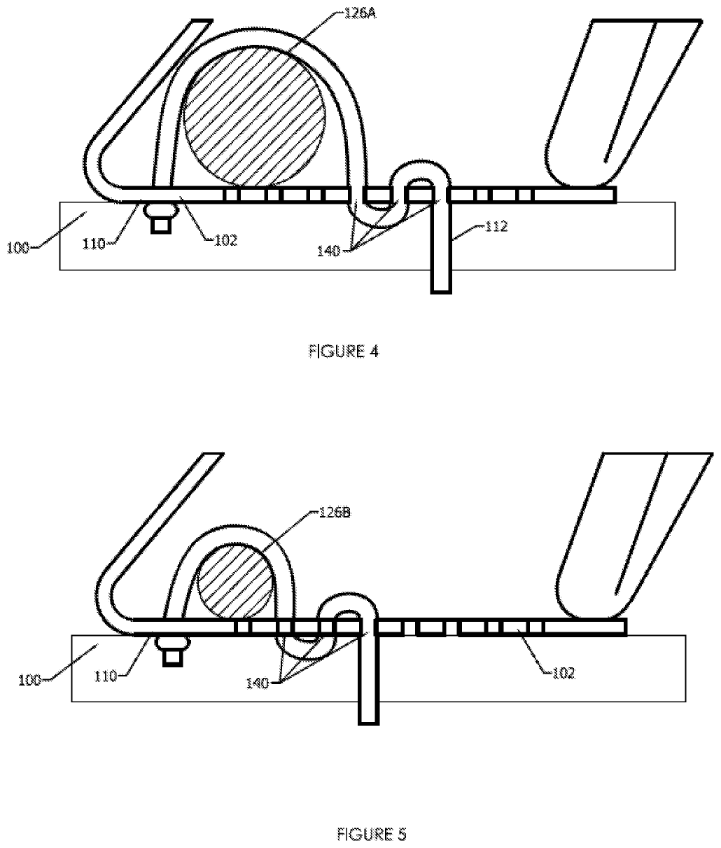

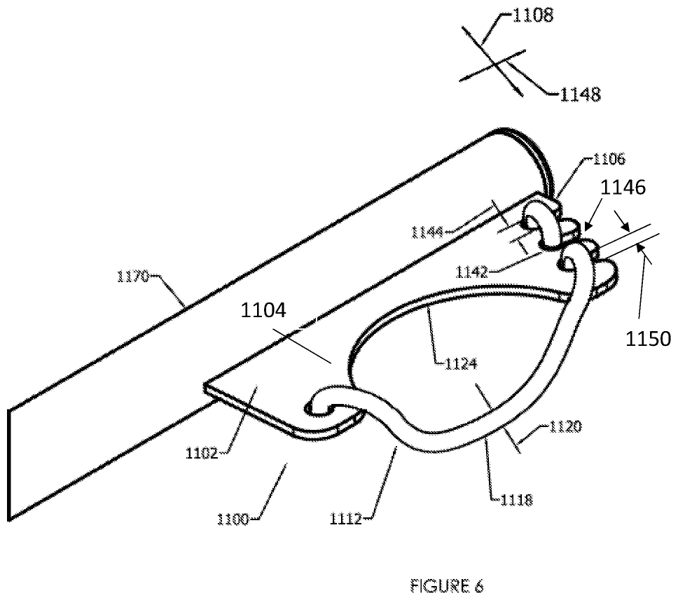

Referring to FIG. 4, the locking mechanism 100 is illustrated securing a relatively wide bicycle tire 126A, while FIG. 5 shows the same locking mechanism 100 configured to secure a relatively narrow bicycle tire 126B. As illustrated in these figures, the same plate 102 and retaining rope 112 can be used to secure both tires 126A and 126B, with the rope 112 be engaged in different ones of the plurality of retaining recesses 140 in each example so that the first recess 140 that is engaged by the rope 112 is relatively close to the edge of the respective tire.

While the plate 102 in the present example is illustrated as being a separate member that can be attached to the frame of a bicycle carrier rack or stationary storage rack, in other embodiments at least some, and optionally all of the features of the base may be integrally formed with the frame or other option of a bicycle carrier or storage rack or other suitable structure.

Referring to FIG. 5, another example of a locking mechanism 1100 is illustrated. The locking mechanism 1100 is analogous to the mechanism 100, with like features annotated using like reference characters indexed by 1000. In this example, the mechanism 1100 includes a base in the form of a metal plate 1102 that has a generally, solid and flat body portion 1104 that is integrally formed with a frame member 1170 of a bicycle carrier rack and is bounded by side edges, including a first edge 1106 that extends in a generally longitudinal direction 1108. The plate 1102 also defines a generally curved bearing surface 1124 that can contact the bicycle tire when the mechanism is in use.

This mechanism 1100 includes a retaining member in the form of rope 1112, with a body portion 1118 having a width 1120, and a plurality of retaining recesses 1140 (three in this example). Each recess 1140 has a respective retaining portion 1142, with width 1144, and a throat portion 1150, that extends in the lateral direction 1148 and has a throat width 1150 that is less than the receiving portion width 1144. While the recesses 1140 are of a slightly different orientation relative to the bearing surface 1124, as compared to the orientation of the recesses 140 relative to the bearing surface 124,

For the purposes of describing dimensional values/ranges and other such parameters herein the phrase “about” or “approximately” means a difference from the stated values or ranges that does not make a material difference in the operation of the systems and processes described herein, including differences that would be understood a person of skill in the relevant art as not having a material impact on the present teachings. For example, a flange angle of about 30 degrees would be understood by a skilled person to include minor deviations from that angle, such as +/−15-20%, provided that the deviations did not interfere with function of the flange or make it unsuitable for engaging and supporting a bicycle wheel/tire. Similarly, minor variations in the throat width or deviations from a specific stated dimension may be considered to be “about” the given dimension and would not be considered material if the throat can still generally, snugly accept a given retaining member/rope and remains relatively narrower than the associated receiving portion.

Embodiments of the apparatuses/mechanisms described herein have been field tested by the inventors with a number of different bicycle tire widths and under a variety of conditions from dry and dusty, to wet and muddy. The apparatuses were subjected to a range of forces by transporting bicycles off-road and deliberately seeking out rough terrain that would place more stress in the locking apparatus. From this testing, the Inventors were able to conclude that the locking mechanisms function as described herein, and generally provide adequate friction to the rope to prevent the rope from slipping or unravelling whilst also providing enough strength and security to prevent unwanted movement of the wheel and limit and/or prevent accidental release.

All publications, patents, and patent applications referred to herein are incorporated by reference in their entirety to the same extent as if each individual publication, patent, or patent application was specifically and individually indicated to be incorporated by reference in its entirety. It is understood that the teachings of the present application are exemplary embodiments and that other embodiments may vary from those described. Such variations are not to be regarded as a departure from the spirit and scope of the teachings and may be included within the scope of the following claims.

What is claimed is:

1. An adjustable locking mechanism for releasably securing a bicycle having a rim and a tire to a rack, the mechanism comprising:
a) a base member connectable to a rack and having a first edge extending in a longitudinal direction, an anchor portion and a first bearing surface configured to bear against a tire of a bicycle;
b) a flexible, rope like retaining member having a body portion defining a retaining member width and extending between a first end that is securable to the anchor portion and a free, second end, wherein the retaining member is substantially inextensible along its length and the body portion is resiliently compressible;
c) at least three securing recesses formed in the base member and being longitudinally spaced apart from each other, each securing recess comprising:
i. a receiving portion extending through the base member and configured to accommodate the body portion of the retaining member and having a receiving portion width;
ii. a throat portion extending laterally inwardly from first edge of the base member to the receiving portion and having a throat width that is less than the receiving portion width and the retaining member width; and
iii. a shelf surface formed at the intersection of the receiving portion and the throat portion and facing the receiving portion;
wherein when the tire is bearing against the first bearing surface and the retaining member is tightened over the tire and a rim of the bicycle to urge the tire against the first bearing surface:
the locking mechanism is engaged by laterally sliding the body portion of the retaining member through the throat portions with sufficient insertion force to compress the body portion to the throat width and allow it to travel through the throat portions to the receiving portions where the body portion expands to the receiving portion width and lateral removal of the retaining member from the receiving portions is inhibited by interference between the retaining member and the shelf surfaces; and
the locking mechanism is disengaged by laterally pulling the retaining member from the receiving portions with a removal force that is sufficient to overcome the interference between the retaining member and the shelf surfaces, thereby causing the body portion of the retaining member to compress to the throat width and to be laterally removed via the throat portions.

2. An adjustable locking mechanism for releasably securing an object, the locking mechanism comprising:
a) a base member having a first edge extending in a longitudinal direction, an anchor portion and a first bearing surface configured to bear against the object;
b) a flexible, rope like retaining member having a body portion defining a retaining member width and extending between a first end that is securable to the anchor portion and a free, second end, wherein the retaining member is substantially inextensible along its length and the body portion is resiliently compressible;
c) at least first and second securing recesses formed in the base member and being longitudinally spaced apart from each other, each securing recess comprising:
i. a receiving portion extending through the base member and configured to accommodate the body portion of the retaining member and having a receiving portion width;
ii. a throat portion extending laterally inwardly from first edge of the base member to the receiving portion and having a throat width that is less than the receiving portion width and the retaining member width; and
iii. a shelf surface formed at the intersection of the receiving portion and the throat portion and facing the receiving portion.

3. The locking mechanism claim 2, further comprising a third securing recess formed in the base and longitudinally spaced from the first and the second securing recesses.

4. The locking mechanism of claim 2, wherein when the object is bearing against the first bearing surface and the retaining member is tightened over the object to urge the object against the first bearing surface:
a) the locking mechanism is engaged by laterally sliding the body portion of the retaining member through the throat portions with sufficient insertion force to compress the body portion to the throat width and allow it to travel through the throat portions to the receiving portions where the body portion expands to the receiving portion width and lateral removal of the retaining member from the receiving portions is inhibited by interference between the retaining member and the shelf surfaces; and
b) the locking mechanism is disengaged by laterally pulling the retaining member from the receiving portions with a removal force that is sufficient to overcome the interference between the retaining member and the shelf surfaces, thereby causing the body portion of the retaining member to compress to the throat width and to be laterally removed via the throat portions.

5. The locking mechanism of claim 3, further comprising a plurality of securing recess formed in the base and longitudinally spaced from each other and from the first, second and third securing recesses.

6. The locking mechanism of claim 1, wherein the receiving portion width is equal to or greater than the retaining member width.

7. The locking mechanism of claim 1, wherein the retaining member width remains substantially constant along its length.

8. The locking mechanism of claim 1, wherein each throat portion is substantially linear and extends along a throat axis that intersects the longitudinal direction.

9. The locking mechanism of claim 1, wherein the retaining member width is between about 4 mm and 30 mm.

10. The locking mechanism of claim 1, wherein the retaining member is detachable from the base member by disconnecting the first end of the retaining member from the anchor portion.

11. The locking mechanism of claim 10, wherein a replacement retaining member is attachable to the base member in place of the retaining member by connecting a first end of replacement retaining member to the anchor portion.

12. The locking mechanism of claim 10 wherein the anchor portion comprises an aperture extending through the base member that is sized to receive the flexible retaining member, and wherein the first end of the flexible retaining member comprises a stopper portion that cannot pass through the aperture.

13. The locking mechanism of claim 12, wherein the stopper portion comprises a knot tied toward the first end of the flexible retaining member.

14. The locking mechanism of claim 1, wherein the throat width is between 85% and 99% of the retaining member width.

15. The locking mechanism of claim 1, wherein the retaining member comprises at least one of a rope, a wire, a cable.

16. The locking mechanism of claim 14, wherein the retaining member is piece of multi-strand rope.

17. The locking mechanism of claim 15, wherein an outer surface of the retaining member is configured to be softer than an outer surface of the object, whereby the retaining member will not scratch the outer surface of the object.

18. The locking mechanism of claim 1, further comprising a flange extending from the base between a root and a free end and having an inner surface that overhangs the base and comprises a second bearing surface, the second bearing surface being spaced from the first bearing surface and being configured to bear against a second portion on the object when the object is secured with the locking mechanism.

19. The locking mechanism of claim 18, wherein the anchor location is laterally proximate the root of the flange and is overlaid by the flange.

20. The locking mechanism of 18, wherein the inner surface of the flange is generally planar and extends at a flange angle relative to the base, and wherein the flange angle is between 15 and 75 degrees.
